(19) United States
(12) Patent Application Publication
(10) Pub. No.: US 2005/0194539 A1
(43) Pub. Date: Sep. 8, 2005

(54) Method for improving measurement accuracy of infrared imaging radiometers

(76) Inventors: Gerard DiTaranto, Parsippany, NJ (US); James LaGrotta, Boonton Twp, NJ (US); Frank Vallese, Montville, NJ (US)

Correspondence Address: HOFFMAN, WASSON & GITLER, P.C.;Crystal Center 2, Suite 522, 2461 South Clark Street, Arlington, VA, 22202, US

(21) Appl. No.: 11/071,477

(22) Filed: Mar. 4, 2005

Related U.S. Application Data
(60) Provisional application No. 60/549,917, filed on Mar. 5, 2004.

(51) Int. Cl. G01J 5/02

(52) U.S. Cl. 250/338.1

(57) ABSTRACT

The present invention is directed to a method for improving measurement accuracy of infrared imaging radiometers utilizing a small infrared detector array, for example 160×120 pixels. The detector offset is changed so that the detector output, when observing a particular object, is constant over a range of ambient temperatures resulting in a constant dynamic range. A radiometric deconvolution is used in order to correct for measurement inaccuracies due to an object's small size.

### CROSS-REFERENCED APPLICATION

The present application claims the priority of provisional patent application Ser. No. 60/549,917, filed Mar. 5, 2004.

### FIELD OF THE INVENTION

The present invention is directed to the field of infrared imaging and radiometric cameras.

### BACKGROUND OF THE INVENTION

In an effort to lower the cost of infrared imaging radiometers, small low-resolution and non-temperature-stabilized detector arrays have recently been incorporated in calibrated systems. For example, previous detector arrays generally would utilize 320×240 pixels with a 50-micron pitch. These pixels would generally utilize a 16×12 mm active area and would generally include thermoelectric (TE) coolers having a fixed temperature set point. The recently developed small low-resolution and non-temperature-stabilized detector arrays would typically utilize 160×120 pixels with a 25-micron pitch. These pixels would generally utilize an active area of 4×3 mm. Additionally, these smaller arrays would not include detector temperature stabilization. The reduction in the number of pixels and the size of the array results in reduced processing time and the requirement for smaller, less expensive optics. The removal of the TE cooler would also reduce costs. As a consequence, infrared imaging radiometers can be produced at a smaller and lower in cost than those radiometers previously available.

The use of lower resolution detector arrays significantly impacts the system modulation transfer function (MTF). This results in radiometric measurements that are inappropriately dependent on the apparent image size of the object. In addition, the output images have reduced contrast and a reduced ability to discern small objects. Infrared imaging radiometers in particular in which the object temperature is calculated by measuring the object's apparent blackbody radiation, would result in an object size dependency to the temperature calculation of that object. As a consequence, in order to produce accurate quantitative radiance measurements for these lower resolution array radiometric cameras that are independent of the image size, a substantial minimum image size would then be required. As an example, for a radiometric infrared camera, to maintain the same uncorrected accuracy, a 160×120-based camera would need images of objects on the display to be four times larger than that of a 320×240-based camera. Additionally, the removal of the TE cooler would result in a variation of the base line response of the unit and consequently adversely impact radiometric accuracy.

### SUMMARY OF THE INVENTION

The deficiencies of the prior art are overcome utilizing the present invention, which is directed to a method for improving the qualitative and quantitative measurement performance of infrared imaging and radiometric cameras. Traditional methods of determining the measurement performance of these cameras have inaccuracies due to the effects of changes in ambient temperature, as well as the size of the objects.

The method of the present invention would use a specific deconvolution technique designed to maintain radiometric accuracy as well as to correct for the object size due to detector objective lens MTF.

### BRIEF DESCRIPTION OF THE DRAWINGS

FIG. 1 is a block diagram of a prior art system; and

FIG. 2 is a block diagram of the approach of the present invention.

### DETAILED DESCRIPTION OF THE PRESENT INVENTION

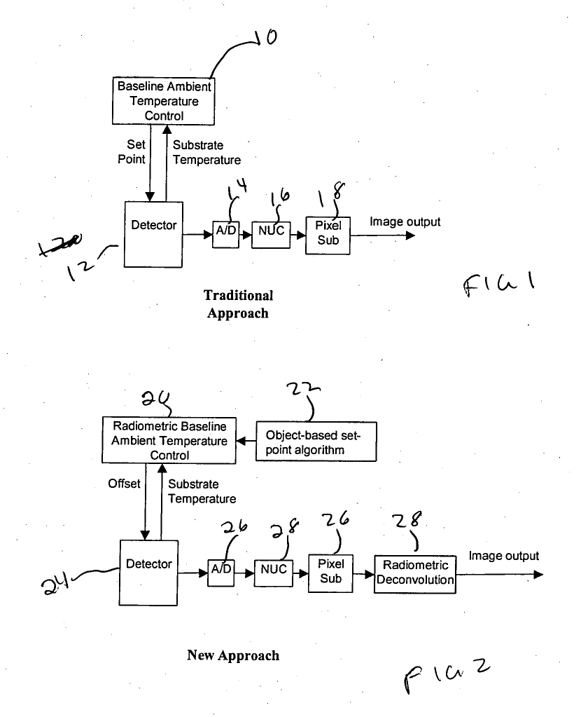

FIG. 1 describes a traditional method of controlling an infrared detector array 12 as is used in an infrared camera. This method incorporated a baseline ambient temperature control 10 employing a fixed temperature set-point. The actual detector temperature would be read by the baseline ambient temperature control 10 which would then apply an offset to the detector array in order to achieve a fixed set-point. However, this approach does not permit the control of the apparent object temperature range for different detector array temperatures. As a result, the dynamic range for the camera may vary in an unexpected fashion. Information produced by the detector array 12 is an analog form which would be converted into digital information utilizing an A/D converter 14. This information would then be passed to a non-uniformity correction NUC algorithm 16 as well as a pixel substitution process 18 thereby producing a corrected image output stream. The NUC is used to compensate for detector cell variation in gain and level across the entire detector array.

The method according to the present invention specifically changes the detector offset as shown in FIG. 2 so that the detector output, when observing a certain object, is constant over a range of ambient temperatures. A unique radiometric baseline ambient temperature control 20 utilizes a flux-based set-point algorithm 22 to produce the offset which is read by the radiometric baseline temperature control 20 to the detector 24. The flux-based set-point algorithm, along with the radiometric baseline ambient temperature control, would also utilize the detector array baseline temperature which would be transmitted from the detector 24 to the radiometric baseline ambient temperature control 20. The detector offset value is changed based upon the detector array baseline temperature and the results of a pre-calibration method for determining the proper set-point. It is noted that this method differs from the traditional approach in which the set-point remains fixed.

In order to correct for errors associated with the object's size, a real-time radiometric deconvolution is performed based upon the information received from an A/D converter 26 for converting the analog information produced by the detector 24 into a digital signal. This digital signal is transmitted to a NUC 28 as well as the pixel substituted signal 26 to produce a data stream after the radiometric deconvolution is utilized.

The radiometric deconvolution is performed on the non-uniformity-corrected pixel substituted signal. Unlike traditional deconvolution methods, the present invention employs an energy-conserving approach that is specifically designed to maintain radiometric accuracy as well as to correct for the optical size variations due to the sensor and objective lens MTF. To implement this method, the camera's optical system is modeled using an observed image g(x,y) and can be estimated as the convolution of the true image f(x,y), as well as the modulation transfer function (MTF), h(x,y) contaminated by noise and n(x,y) that can occur from various sources. The system MTF is normally a combination of the MTF due to the objective lens as well as the detector. Several well-known linear image restoration techniques exist to determine the corrected image based on the point spread function and distorted image, including inverse filtering, Wiener filtering, least-squares filtering, recursive Kalman filtering and constrained iterative deconvolution methods.

Various embodiments of the invention have been described. The description is intended to be illustrative, and not limited. Thus, it would be apparent to one skilled in the art that certain modifications may be made to the invention as described without departing from the scope of the claims set out below.

1. A method for improving the measurement accuracy of infrared imaging radiometers, comprising the steps of
receiving an observed image in an infrared detector array;
estimating the convolution of the true image; and
radiometrically deconvolving said true image utilizing a modulation transfer function.

2. The method in accordance with claim 1, including the steps of initially producing a detector offset value;
changing said detector offset value based upon the baseline temperature of said detector.

3. The method in accordance with claim 2, further including the step of determining a proper set-point utilizing a pre-calibration algorithm.

4. The method in accordance with claim 1, in which said detector is an array containing 160×120 pixel elements.

5. The method in accordance with claim 2, in which said detector is an array containing 160×120 pixel elements.

6. The method in accordance with claim 3, in which said detector is an array containing 160×120 pixel elements.

7. The method in accordance with claim 4, wherein said array has a 25-micron pitch and a 4×3 mm active area.

8. The method in accordance with claim 5, wherein said array has a 25-micron pitch and a 4×3 mm active area.

9. The method in accordance with claim 6, wherein said array has a 25-micron pitch and a 4×3 mm active area.
